(19) United States
(12) Patent Application Publication
(10) Pub. No.: US 2002/0051491 A1
(43) Pub. Date: May 2, 2002

(54) EXTRACTION OF FOREGROUND INFORMATION FOR VIDEO CONFERENCE

(76) Inventors: KIRAN CHALLAPALI, STAMFORD, CT (US); RICHARD Y. CHEN, CROTON-ON-HUDSON, NY (US)

Correspondence Address: CORPORATE PATENT COUNSEL, U S PHILIPS CORPORATION, 580 WHITE PLAINS ROAD, TARRYTOWN, NY, 10591

(21) Appl. No.: 09/196,574

(22) Filed: Nov. 20, 1998

(51) Int. Cl. H04N 7/12

(52) U.S. Cl. 375/240.2

(57) ABSTRACT

An image processing device which improves the transmission of image data over a low bandwidth network by extracting foreground information and encoding it at a higher bit rate than background information.

### BACKGROUND OF THE INVENTION

1. Field of the Invention

The invention relates in general to image processing and in particular to the extraction and variable bit rate encoding of foreground and background information from a stereo pair of images for video conferencing applications.

2. Description of the Prior Art

In all video conference applications, the bandwidth of communication between the participants is typically limited, about 64 kilo bits per second for a telephone line connection. Better compression standards have been developed over the years for efficiently compressing low-bitrate audio and video data, for example H.263 and MPEG-4. However, in typical video conference applications, a majority of the picture data in any given scene consists of irrelevant information, for example objects in the background. Compression algorithms cannot distinguish between relevant and irrelevant objects and if all of this information is transmitted on a low bandwidth channel, the result is a delayed jumpy looking video of a video conference participant.

Prior systems, as shown in German Patent DE 3608489 A1, use a stereo pair of cameras to image the video conference participant. A comparison is then made of the two images and using various displacement techniques the contour of the foreground information is located (as described in the above identified German patent and also in Birchfield and Tomasi, “Depth Discontinuities by Pixel-to-pixel Stereo,” Proceedings of the 1998 IEEE International Conference on Computer Vision, Bombay India [“Birchfield”]). Once the contour of the foreground information is located, the background information is also known. A single static background image is then transmitted to a receiver to be stored in memory. The foreground images are encoded and transmitted along with address data which define where in the background image the foreground images should be placed.

The problems with such systems is that the background looks artificial since it lacks all motion and the contour of the video conference participant must be defined with a certain degree of accuracy. In addition the encoder which is typically optimized for a rectangular image such as an 8×8 block of DCT coefficients must encode an oddly shaped image which follows the contour of the video conference participant. This “oddly” shaped information must also be transmitted separately which is a load on both bandwidth and computational resources at both the encoder and decoder sides.

### SUMMARY OF THE INVENTION

Accordingly, it is an object of the invention to extract the foreground information of a video conference image and encode it at a first bit rate and encode the background information at a second lower bit rate. This object is achieved by the use of a pair of cameras arranged such that each camera has a slightly different view of the scene. Two images are produced and the difference in location of corresponding matching pixels in each image is computed and the disparity in location of these pixels is determined. A small disparity between the location of two identical pixels indicates the pixels constitute background information. A large disparity indicates the pixels constitute foreground information. The foreground pixels are then transmitted at the higher bit rate while the background pixels are transmitted at the lower bit rate.

It is a further object of the invention to avoid having to accurately represent the contour of the video conference participant. This object is achieved by using the 8×8 DCT blocks of coefficients to define the contour. Any block that includes a predefined number of foreground pixels is encoded at the higher bit rate, while those blocks that fall below this predefined number are encoded at the lower bit rate.

It is even a further object of the invention to encode the data using a standard encoder which encodes an 8×8 DCT block of coefficients. Again this object is achieved by defining foreground information based on a block of DCT data rather than the precise boundary of the video conference participant.

The invention accordingly comprises the methods and features of construction, combination of elements, and arrangement of parts which will be exemplified in the construction hereinafter set forth, and the scope of the invention will be indicated in the claims.

### BRIEF DESCRIPTION OF THE DRAWINGS

For a better understanding of the invention reference is had to the following drawings:

FIG. 1 shows a video conference scheme which uses a stereo pair of cameras;

FIGS. 2A and 2B show the images that result from the cameras in FIG. 1.

FIG. 3A shows the identification of the foreground information;

FIG. 3B shows the DCT blocks which are transmitted at the higher bit rate;

FIG. 4 shows a block diagram of a video conference device in accordance with the invention;

FIG. 5 shows a PC configured for operating the instant invention; and

FIG. 6 shows the internal structure of the PC in FIG. 5.

### DETAILED DESCRIPTION OF THE PREFERRED EMBODIMENT.

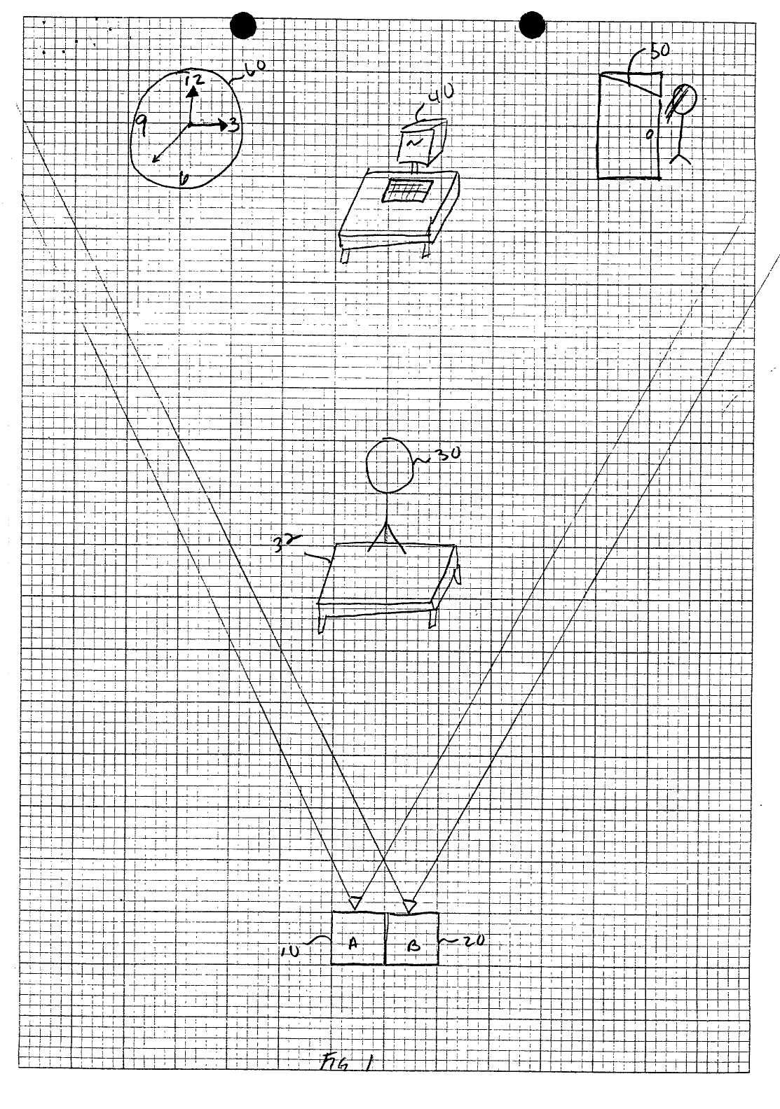

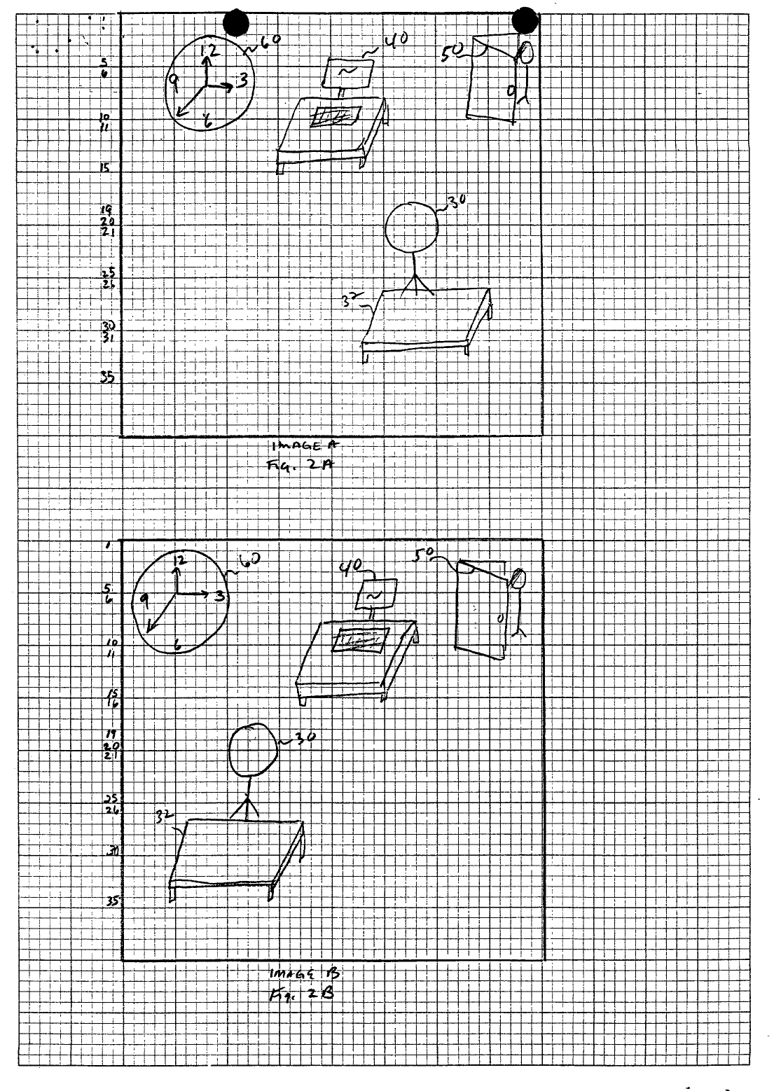

FIG. 1 shows a video conference set up in accordance with the invention. A video conference participant 30 sits at a desk 32 in front of two cameras 10 and 20 slightly spaced from one another. In the background there is a computer 40, a door 50 with people walking in and out, and a clock 60. The view of camera 10 is shown in FIG. 2A as follows: the video conference participant 30 is positioned to the right of the lens of camera 10, the computer 40 since it is a distance from the cameras it remains basically in the center of the image. The door 50 is in the right hand portion of the image. The clock 60 is in the left hand corner of the image.

The view of camera 20 is shown in FIG. 2B as follows: The video conference participant 30 is off to the left in the image. The clock 60 is to the left of the video conference participant 30. The computer 40 is to the right of the video conference participant 30 but still remains basically in the center of the image. The door 50 is in the upper right hand corner of the image.

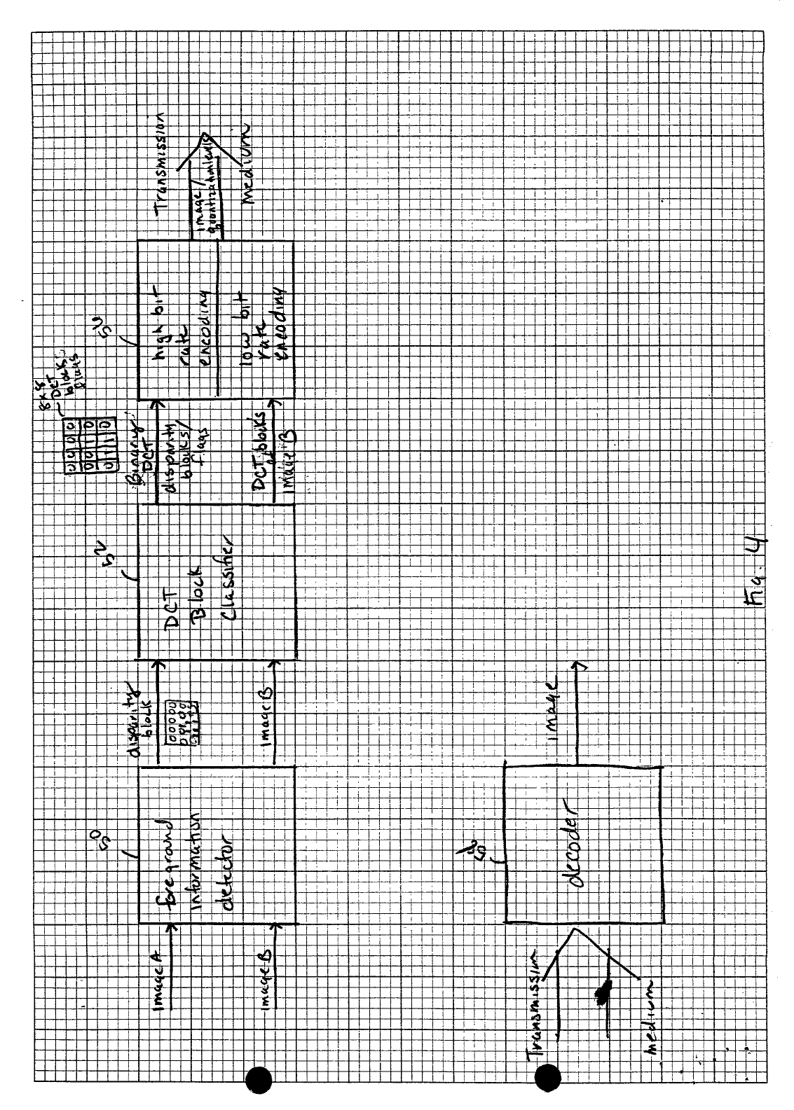

The images received from the two cameras are compared to locate pixels of foreground information. (There are many algorithms that can be used to locate the foreground information such as those described in DE 3608489 and Birchfield hereby incorporated by reference). In a preferred embodiment of the invention, the image from the left camera 10 (image A) is compared to the image from the right camera 20 (image B). The scan lines are lined up, e.g. scan line 19 of image A matches scan line 19 of image B. A pixel on scan line 19 of image A is then matched to its corresponding pixel in scan line 19 of image B. So for example, if pixel 28 of scan line 19 of image A matches pixel 13 of scan line 19 of image B the disparity is calculated at 28−13=15. Because of the closely located cameras, pixels of foreground information will have a larger disparity than pixels of background information. A disparity threshold is then chosen, e.g. 7, and any disparity above the threshold 7 indicates the pixel is foreground information while any disparity below 7 indicates the pixel is background information. These calculations are all performed in the foreground detector 50 of FIG. 4. The output of the foreground detector is one of the images, e.g. image B, and another block of data which is of the same size as the image data and indicates which pixels are foreground pixels, e.g. ‘1’, and which are background pixels, e.g. ‘0’. These two outputs are supplied to a DCT block classifier 52 which creates 8×8 DCT blocks of the image and also binary blocks which indicate which DCT blocks of the image are foreground and which are background information. Depending on the number of pixels in a particular DCT block that are foreground information, which can be a predefined threshold or vary as the bit rate capacity of the channel varies, the block will either be identified to the encoder 56 as a foreground block or a background block.

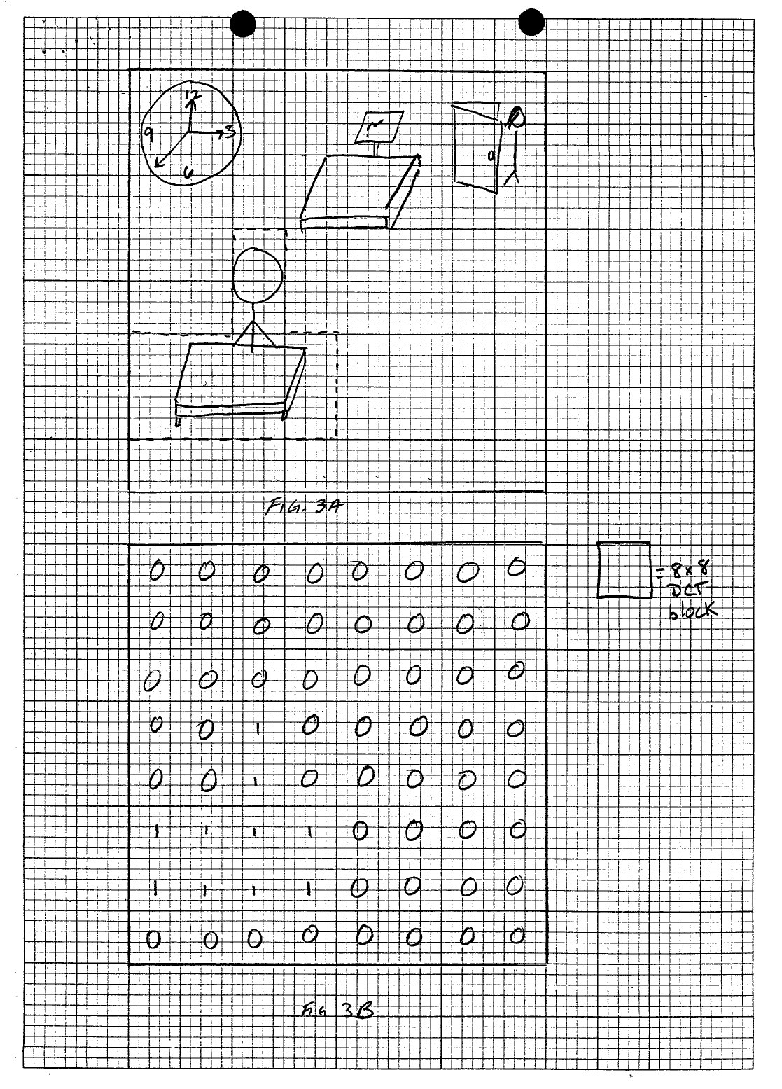

FIG. 3A shows image B with the dashed lines representing the information that is encoded as foreground information in accordance with the invention. Assume each square represents an 8×8 DCT block. A foreground threshold is set such that if any pixel within an 8×8 block is foreground information then the entire block must be encoded as foreground information. The dashed lines in FIG. 3A indicate the DCT blocks identified as foreground information, these blocks will be encoded with a finer quantization level.

FIG. 3B shows a binary DCT disparity block which is the output of DCT block classifier 52. Encoder 56 receives both the image B and the binary DCT disparity blocks. Any DCT block which corresponds to a logic ‘1’ DCT disparity block is encoded finely. Any DCT block which corresponds to a logic ‘0’ DCT disparity block is encoded coarsely. The result is most of the bandwidth of the channel is dedicated to the foreground information and only a small portion allocated to background information. A decoder 58 receives the bitstream and decodes it according to the quantization levels provided in the bitstream.

This invention has applications wherever there is a transmission of moving images over a network such as the Internet, telephone lines, videomail, video phones, digital television receivers etc.

In a preferred embodiment of the invention, the invention is implemented on a digital television platform using a Trimedia processor for processing and the television monitor for display. The invention can also be implemented similarly on a personal computer.

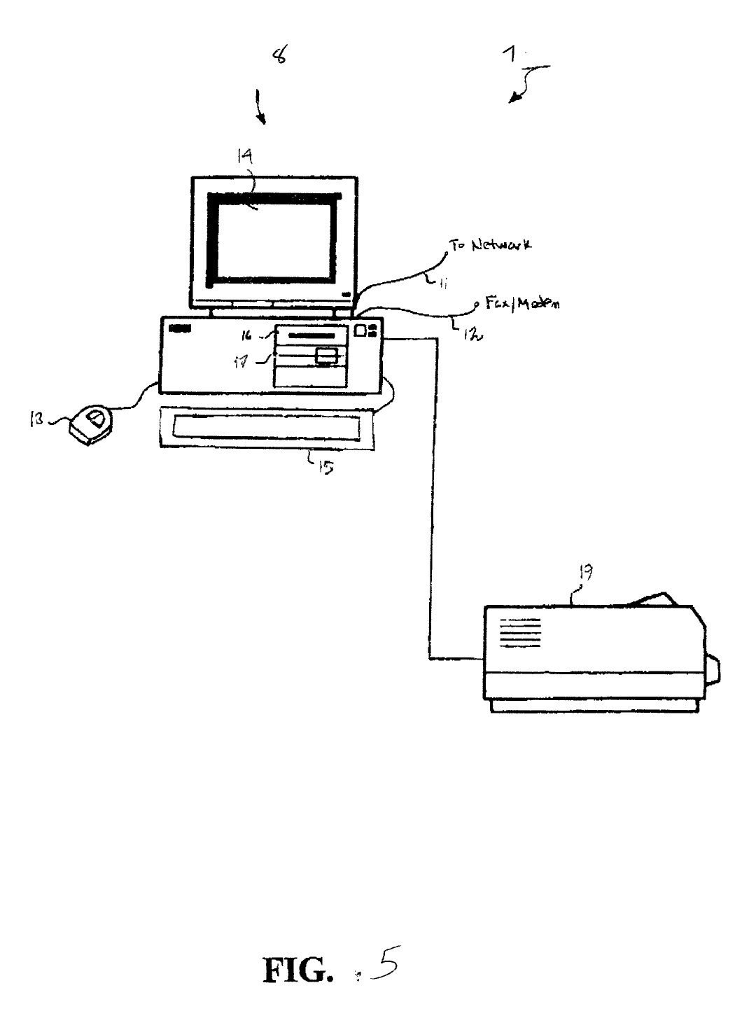

FIG. 5 shows a representative embodiment of a computer system 7 on which the present invention may be implemented. As shown in FIG. 5, personal computer (“PC”) 8 includes network connection 11 for interfacing to a network, such as a variable-bandwidth network or the Internet, and fax/modem connection 12 for interfacing with other remote sources such as a video camera (not shown). PC 8 also includes display screen 14 for displaying information (including video data) to a user, keyboard 15 for inputting text and user commands, mouse 13 for positioning a cursor on display screen 14 and for inputting user commands, disk drive 16 for reading from and writing to floppy disks installed therein, and CD-ROM drive 17 for accessing information stored on CD-ROM. PC 8 may also have one or more peripheral devices attached thereto, such as a pair of video conference cameras for inputting images, or the like, and printer 19 for outputting images, text, or the like.

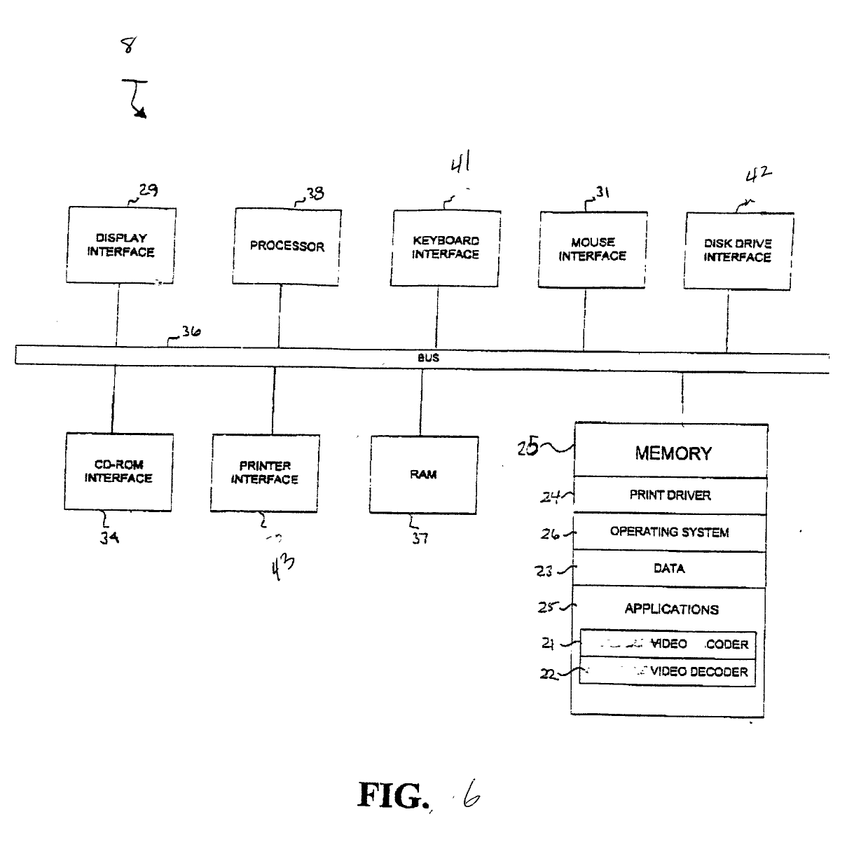

FIG. 6 shows the internal structure of PC 8. As shown in FIG. 5, PC 8 includes memory 25, which comprises a computer-readable medium such as a computer hard disk. Memory 25 stores data 23, applications 25, print driver 24, and operating system 26. In preferred embodiments of the invention, operating system 26 is a windowing operating system, such as Microsoft® Windows95; although the invention may be used with other operating systems as well. Among the applications stored in memory 25 are foreground information detector/DCT block classifier/video coder 21 (‘video coder 21’) and video decoder 22. Video coder 21 performs video data encoding in the manner set forth in detail above, and video decoder 22 decodes video data which has been coded in the manner prescribed by video coder 21. The operation of these applications has been described in detail above.

Also included in PC 8 are display interface 29, keyboard interface 41, mouse interface 31, disk drive interface 42, CD-ROM drive interface 34, computer bus 36, RAM 37, processor 38, and printer interface 43. Processor 38 preferably comprises a microprocessor or the like for executing applications, such those noted above, out of RAM 37. Such applications, including video coder 21 and video decoder 22, may be stored in memory 25 (as noted above) or, alternatively, on a floppy disk in disk drive 16 or a CD-ROM in CD-ROM drive 17. Processor 38 accesses applications (or other data) stored on a floppy disk via disk drive interface 32 and accesses applications (or other data) stored on a CD-ROM via CD-ROM drive interface 34.

Application execution and other tasks of PC 8 may be initiated using keyboard 15 or mouse 13, commands from which are transmitted to processor 38 via keyboard interface 41 and mouse interface 31, respectively. Output results from applications running on PC 8 may be processed by display interface 29 and then displayed to a user on display 14 or, alternatively, output via network connection 11. For example, input video data which has been coded by video coder 21 is typically output via network connection 11. On the other hand, coded video data which has been received from, e.g., a variable bandwidth-network is decoded by video decoder 22 and then displayed on display 14. To this end, display interface 29 preferably comprises a display processor for forming video images based on decoded video data provided by processor 38 over computer bus 36, and for outputting those images to display 14. Output results from other applications, such as word processing programs, running on PC 8 may be provided to printer 19 via printer interface 43. Processor 38 executes print driver 24 so as to perform appropriate formatting of such print jobs prior to their transmission to printer 19.

It will thus be seen that the objects set forth above, and those made apparent from the preceding description are efficiently obtained and, since certain changes may be made in the above construction without departing from the spirit and scope of the invention, it is intended that all matter contained in the above description or shown in the accompanying drawings shall be interpreted as illustrative and not in a limiting sense.

It is also to be understood that the following claims are intended to cover all the generic and specific features of the invention herein described, and all statements of the scope of the invention, which, as a matter of language, might be said to fall therebetween.

What is claimed is:

1. An image processing device, comprising:
an input which receives a stereo pair of images;
a foreground extractor coupled to the input which compares location of like pixel information in each image to determine which pixel information is foreground pixel information and which pixel information is background pixel information;
a DCT block classifier coupled to the foreground extractor which determines which DCT blocks of at least one of the images contain a threshold amount of foreground information;
an encoder coupled to the DCT block classifier which encodes the DCT blocks having the threshold amount of foreground information with a first level of quantization and which encodes the DCT blocks having less than the threshold amount of foreground information at a second lower quantization level.

2. The image processing device as claimed in claim 1, wherein the stereo pair of images are received from a stereo pair of cameras spaced closely from one another in a video conference system.

3. The image processing device as claimed in claim 1, wherein the foreground extractor computes the difference in location of like pixels in each image and selects the foreground pixels as those pixels whose difference in location falls above a threshold distance.

4. An image processing device, comprising:
an input which receives a stereo pair of images;
a foreground extractor which detects foreground pixel information from the stereo pair of images; and
an encoder coupled to the foreground extractor which encodes the foreground pixel information at a first high level of quantization and which encodes background pixel information at a second lower level of quantization.

5. The image processing device as claimed in claim 4, wherein the foreground extractor computes the difference in location of like pixels in each image and selects the foreground pixels as those pixels whose difference in location falls above a threshold distance.

6. The image processing device as claimed in claim 4, wherein the foreground pixel information is defined in terms of entire 8×8 blocks of DCT coefficients.

7. An image processing system, comprising:
a stereo pair of cameras for taking a stereo pair of images;
a foreground extractor which detects foreground pixel information from the stereo pair of images; and
an encoder coupled to the foreground extractor which encodes the foreground pixel information at a first high level of quantization and which encodes background pixel information at a second lower level of quantization.

8. A method of encoding a stereo pair of images, comprising:
receiving the stereo pair of images;
extracting foreground information from the stereo pair of images; and
encoding the foreground information at a first higher quantization level and encoding background information of the stereo pair of images at a second lower quantization level.

9. The method in accordance with claim 8, wherein the step of extracting includes the following steps:
identifying the locations of like pixels in each of the stereo pair of images;
calculating the difference between the locations of like pixels; and
determining for each set of like pixels whether the difference between locations falls above a threshold difference, and if so identifying those pixels as foreground information.

10. The method in accordance with claim 8, wherein the encoding step encodes an entire 8×8 block of DCT coefficients as foreground information if at least a predetermined number of foreground pixels are within the 8×8 block, otherwise the entire 8×8 block of DCT coefficients is encoded as background information.

11. Computer-executable process steps to process image data from a stereo pair of images, the computer-executable process steps being stored on a computer-readable medium and comprising:
a foreground extracting step to detect foreground pixel information from the stereo pair of images; and
an encoding step for encoding foreground pixel information of at least one image at a first higher quantization level and for encoding background pixel information of the at least one image at a second lower quantization level.

12. The computer-executable process steps as claimed in claim 11, wherein the foreground extracting step determines which 8×8 DCT blocks contain at least a predetermined amount of foreground pixel information; and wherein the encoding step encodes the entire 8×8 block of DCT coefficients at the first higher quantization level if the 8×8 block of DCT coefficients contains the predetermined amount of foreground pixel information.

13. The computer-executable process steps as claimed in claim 11 and 12, wherein the step of foreground extracting computes the difference in location of like pixels in each image and selects the foreground pixels as those pixels whose difference in location falls above a threshold distance.

14. An apparatus for processing a stereo pair of images, the apparatus comprising:
a memory which stores process steps; and
a processor which executes the process steps stored in the memory so as (I) to extract foreground information from the stereo pair of images and (ii) to encode the foreground information at a first high level of quantization and to encode background information at a second low level of quantization.

15. An apparatus for processing a stereo pair of images, the apparatus comprising:
a memory which stores process steps; and
a processor which executes the process steps stored in the memory so as (I) to extract foreground information form the stereo pair of images in the form of foreground 8×8 DCT blocks of coefficients, and (ii) to encode the foreground 8×8 DCT blocks of coefficients at a first high level of quantization and to encode background 8×8 DCT blocks of coefficients at a second lower level of quantization.

16. An apparatus for processing a stereo pair of images, the apparatus comprising:
a memory which stores process steps; and
a processor which executes the process steps stored in memory so as (I) to calculate the difference in location of like pixels in each image, (ii) if the difference in location is above a set threshold the pixel information is identified as foreground pixel information, if below the set threshold the pixel information is determined to be background pixel information, (ii) to determine whether each 8×8 DCT block contains a particular amount of foreground pixel information and (iv) to encode those 8×8 DCT blocks having at least the particular amount of foreground information at a first higher level of quantization and those 8×8 DCT blocks having less than the particular amount of foreground information at a second lower level of quantization.
